(19) United States
(12) Patent Application Publication
(10) Pub. No.: US 2010/0266333 A1
(43) Pub. Date: Oct. 21, 2010

(54) CONNECTION APPARATUS

(75) Inventors: Bernhard OSWALD, Kapfenberg (AT); Ägyd PENGG, Portschach (AT)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: Pewag Austria GmbH, Kapfenberg (AT)

(21) Appl. No.: 12/762,159

(22) Filed: Apr. 16, 2010

(30) Foreign Application Priority Data
Apr. 17, 2009 (EP) 09 005 509.6

(51) Int. Cl. F16D 1/12

(52) U.S. Cl. 403/164

(57) ABSTRACT

A connection apparatus for coupling a support flange to a load, comprising a housing having a bushing and a holder for the support flange twistable about the bushing, the support flange swivelable about a rotation axis perpendicularly to the rotation axis of the holder. A bolt rotatably extends through the bushing with an upper head part, protruding axially, its axial end exposed for receiving a load, and held in an interlocking manner against axial withdrawal. The supporting bolt comprises a shank region at an axial distance (a) with a radially enlarged shank diameter whose radial excess portion is partly covered from the outside under axial play within said axial distance by a bushing section with a reduced inside diameter.

### RELATED APPLICATION

The current application claims priority to European Patent Application No. 09 005 509.6 filed on Apr. 17, 2009. Said application is incorporated by reference herein.

### BACKGROUND OF THE INVENTION

The invention relates to a connection apparatus for coupling a support flange to a load, comprising a housing having a bushing and a holder for the support flange which is twistable about the bushing, with the support flange being swivelable in the housing about a rotation axis which is disposed perpendicularly in relation to the rotation axis of the holder and a through-hole extends axially through the bushing in which a holding bolt is rotatably attached with an upper head part and protrudes axially with its axial end averted from the head part beyond the housing for fixing a load, with the holding bolt being held in the mounted state in the through-hole in an interlocking manner against axial withdrawal from the same.

Such connection apparatuses are frequently especially used for lifting loads. For this purpose, the connection apparatus is fastened to the load and then lifted on its support flange, which is often arranged as a support ring, by means of a lifting hook or a chain or the like and moved to another location.

An apparatus of this kind is described in EP 1 069067 81. In this case, the shank of the supporting bolt and the bushing in which it sits are connected with one another by means of shrinkage, with the upper end of the bushing resting on the head section of the supporting bolt. There is a disadvantage in this known connection apparatus that the absolutely tight connection between shank of the supporting bolt and the bushing will lead to the consequence that any rotation of the supporting bolt, irrespective of how this is caused, will inevitably lead to a rotation of the bushing. For this reason, the bushing will rotate during the tightening of the bolt (which occurs when the load is bolted on) and thus also the flange resting on the upper side of the load and attached to the bottom of the bushing will also rotate together with the rotation of the bolt. As a result, during the tightening of the bolt it is necessary to additionally overcome the friction between the flange and the load on which it rests, especially in the end region of tightening the bolt, leading to a considerable enlargement in the required tightening torque of the bolt. It is possible that the bolt cannot be pretensioned in a completely secure manner when the flange of the bushing and its contact surface with the load are not disposed in a precisely parallel manner with respect to one another. When the shrinking of the bushing on the shank of the supporting bolt has been performed, the pre-mounting of this known connection apparatus has been fulfilled, i.e. it can be taken in the otherwise fully mounted state and be attached to the load. The shank is unable to fall out of the bushing.

In the connection apparatus from U.S. Pat. No. 5,248,176 A, two sleeves which are disposed axially behind one another are used instead of a sleeve holding the supporting bolt, each of which is provided with a radially protruding ring flange at their axially outer end. The supporting bolt is freely movable within this holding assembly relative to the same, which assembly is formed by the two sleeves, and is not fixed to the same. This remedies the disadvantage when bolting on the load to be suspended which occurs in the connection apparatus as explained further above by the fixed connection used there between these parts. However, an interlocking fixing is only provided in one embodiment with a central supporting bolt as shown in U.S. Pat. No. 5,248,176 A, with which the supporting bolt is prevented in the assembled state of the connection apparatus from slipping out upwardly from the through-hole formed by the two sleeves in which it is fixed. For this purpose, the thread for bolting on the load provided at the bottom end of the supporting bolt is continued axially up to approx. half the length of the through-hole, with a short coil spring of approx. 1.5 flights sitting in a depression attached to the bottom sleeve, which spring is attached there with tight fit from the outside in the flights of the supporting bolt and protrudes beyond the same to the outside, thus preventing a return of the supporting bolt from the through-hole and thus ensuring that the mounted connection apparatus holds together even when it has not yet been fastened to a load. This known connection apparatus has an overall relatively complex arrangement with a large number of individual elements. Moreover, the holding coil spring is also entrained in a rotating manner when, during its rotation, the supporting bolt is screwed onto the load to be suspended as a result of the narrow seat of the holding coil spring which is held on the supporting bolt between its flights. Within the scope of the required tightening torque of the supporting bolt, it is necessary, especially in the last phase of the tightening of the supporting bolt, to additionally overcome the frictional forces occurring between the holding coil spring and the contacting surface of the load to be coupled.

A connection apparatus of the kind mentioned above is described in U.S. Pat. No. 4,641,986 A. Only a middle bushing is used in which the supporting bolt sits rotatably, with the supporting bolt which rests with its upper side via an intermediate ring on the upper end of the bushing being secured at the bottom end of the bushing in an enlarged recess attached there against upwardly withdrawal by means of circlip embedded in the region of a screw thread for the load to be fastened. When the supporting bolt is now screwed onto the surface of a load to be suspended in this known connection apparatus, then this means that a relative rotation occurs between the circlip and the threaded shank of the supporting bolt, especially during the last tightening stage, which again leads to the consequence as a result of the high tightening forces that in this case to a more or less large part of the required tightening torque needs to be applied for overcoming this friction too, which is undesirable.

### SUMMARY OF THE INVENTION

The invention now proposes a connection apparatus on the basis of the above which has a simple configuration and where virtually no part of the required tightening torque needs to be applied for additionally overcoming frictional forces between the supporting bolt to be screwed in and other elements of the apparatus when a load is bolted on.

This is achieved in accordance with the invention in a connection apparatus of the kind mentioned at the beginning in such a way that the supporting bolt comprises a shank with a shank region provided at an axial distance from the upper end of the bushing and having a radially enlarged shank diameter whose radial excess portion is partly covered radially from the outside in the mounted state under axial play within said axial distance by a bushing section with a reduced inside diameter.

A withdrawal of the supporting bolt upwardly from the through-hole is prevented in the invention in an interlocking manner at first solely by the shaping of the shank of the supporting bolt and by the shaping of the bushing in the through-hole, without requiring the additional provision of further constructional parts (such as circlips, coil springs tightly applied to sit on threads on the supporting bolt shank and the like) as is the case in known connection apparatuses. The supporting bolt can be freely rotated relative to the housing and bushing in the same however. In the arrangement of the connection apparatus in accordance with the invention, there is no additional axial transmission of forces between the supporting bolt on the one hand and any other part of the apparatus on the other hand when the supporting bolt is screwed into the load to be suspended, so that in this respect no frictional moments are built up which act upon the supporting bolt as a result of axial contact forces about the supporting bolt. The permissible tightening moment of the bolt is rather fully available for building up the desired pretension. Whereas the supporting bolt is held in an interlocking manner in the through-hole of the bushing in known connection apparatuses in such a way that it is unable to perform any axial relative motion in relation to the bushing, the interlocking prevention of any axial slipping out from the sleeve used in the invention does not mean, alone due to the required axial play, that no axial relative motion shall be possible between supporting bolt and bushing. In fact, only a complete axial moving out from the sleeve is prevented in an interlocking manner in the embodiment in accordance with the invention, which means that the bolt cannot be fully pulled out axially from the bushing. An axial relative movement between the bolt and the bushing in the manner that the bolt does not fully move out of the bushing is certainly permitted in the invention, i.e. no interlocking fixture is used which principally prevents an axial relative motion between bolt and bushing, as is the case in known connection apparatuses. Depending on the position within the axial distance from the upper end of the bushing where its radially enlarged shank region begins in the case of a mounted supporting bolt, it can be determined already by the configuration of the construction according to the invention over which axial region the supporting bolt, once it has been mounted, can be moved within the scope of axial play within the through-hole axially in relation to the same.

In an especially preferred development of the connection apparatus in accordance with the invention, the shank region with enlarged shank diameter consists of an external thread whose flights form the radial enlargement, and the bushing section with reduced inside diameter consists of an inside thread which corresponds to the thread on the shank region with enlarged shank diameter. In this development, the supporting bolt, when it is mounted in the apparatus, is screwed at first with its external thread which forms the shank diameter enlarging the shank region through the inside thread of the bushing section with reduced inside diameter until the external thread has passed completely through the inside thread. Thereafter, the supporting bolt can be displaced axially in the through-hole of the bushing without any further rotation to such an extent until the head part of the supporting bolt rests on the bushing at the top or on an interposed washer. When the supporting bolt is now moved against its direction of insertion axially in the through-hole in the direction towards its upper end, then this is only possible up until the external thread protruding radially to the outside over the other shank diameter comes to rest on the bushing section with reduced inside diameter which protrudes radially to the inside, which external thread partly covers the same radially from the outside. A further axial displacing motion of the shank in the through-hole is then no longer possible unless a twisting of the supporting bolt is used specially for the intended screwing out or through of its external thread through the inside thread of the bushing.

Preferably, the inside diameter of the bushing is arranged to be larger in the region outside of the bushing section with reduced inside diameter than the outside diameter of the flights on the shank region of the supporting bolt with enlarged shank diameter, so that in the mounted state the shank region with enlarged shank diameter does not rest on the inside wall of the bushing in the bushing region enclosing the same, but has a predetermined play in relation to the same (and also axially), which again promotes the screwing in of the threaded bolt into a load to be bolted.

An especially simple and thus cost-effective development of the invention is that the external thread which is representative of the shank region with enlarged shank diameter is formed directly by the thread which is provided in the end region of the supporting bolt for screwing on the load, which end region faces the load, with the diameter of the remaining region of the shank of the supporting bolt being smaller than the core diameter of said external thread. This leads to the advantage that standard bolts or at least bolts easy to produce can be used, which is very advantageous.

In another embodiment of the invention, the external thread of the shank region with enlarged shank diameter, when the supporting bolt is mounted, is provided in a middle region between the thread for screwing on the load at the end of the supporting bolt averted from the head part thereof and the bushing section with reduced inside diameter. In this solution, the bushing can remain the same for several screw thread sizes. The only change is to the screw thread, which can be advantageous in respect of costs.

For good handling and secure function it is recommended in this embodiment of the invention that the inside diameter in the bushing section with reduced inside diameter comprises at least one complete flight, preferably two complete flights. In a similarly preferred manner, the external thread of the shank region of the supporting bolt with enlarged shank diameter should comprise two, preferably three complete flights.

A further, very advantageous development of the connection apparatus in accordance with the invention is also that the shank region with radially enlarged shank diameter is arranged cylindrically in the supporting bolt and protrudes into an annular groove provided in a respective manner on the inside surface of the bushing, with the radially enlarged shank region sitting in the annular groove radially and axially with play. In this embodiment, the supporting bolt remains slightly twistable in the assembled state in relation to the bushing. The supporting bolt can no longer be removed from the bushing without any additional application of force and is thus always held in the same. As a result, the supporting bolt can be held in the bushing in this embodiment without any further considerable effort (applied work or additional component). During mounting, the supporting bolt is inserted during the insertion into the through-hole up until its cylindrical region with slightly enlarged diameter sits at the beginning of the through-hole, with the latter being provided with a rounded-off portion or bevel at its upper end according to a further preferred development of the invention, thus facilitating the entry of the shank part of the supporting bolt with larger diameter. When the shank region with enlarged diameter is arranged cylindrically, it is pushed through the constricted part of the through-hole by application of force, e.g. by means of a suitable plastic hammer, until it has entered the annular groove with enlarged diameter. It is advantageous to keep the axial length of the shank region with enlarged diameter as small as possible in order to reduce the effort for pushing through the upper entrance region of the throughhole. It needs to be ensured however that in the mounted state the shank region of enlarged diameter of the supporting bolt which is accommodated in the annular groove also sits in the annular groove with the required axial play, wherein the same can optionally also be relatively small, but needs to ensure easy and unobstructed twisting of the supporting bolt in the through-hole.

The supporting bolt is arranged in an especially preferable way with its shaft made of a material with a higher strength than that of the bushing in such an embodiment of the invention, thus facilitating the driving through the narrower opening region of the through-hole. The enlarged diameter of the shank region of the supporting bolt is chosen to protrude radially only to such an extent that driving the supporting bolt with moderate effort through the narrow region of the through-hole is easily possible. It has been seen to be advantageous when the other nominal width of the through-hole is covered by 0.1 to 0.075 mm by the outside diameter of the cylindrical shank region with enlarged diameter. It can be seen from this that even very small diameter differences can lead to a sufficiently good axial fit of the region of the supporting bolt with enlarged diameter in relation to the bushing section with reduced inside diameter and ensure a sufficient axial fixing against undesirable slipping of the supporting bolt out of the through-hole.

A further advantageous development of the invention is also that the supporting flange is held in the housing in such a way that it is fixed in any of its possible swiveling positions in a self-arresting way. This is preferably achieved in such a way that the supporting flange is placed under pretension by means of pretensioning means which act in the direction of its rotational axis and rest against the same, which pretension holds it in a self-arresting manner in the swiveling direction in any of its possible swiveling positions. This is preferably achieved in such a way for example that the supporting flange is provided at its bottom end with two mutually facing pivot pins which each engage from the outside into the housing, with the pretensioning means acting upon the axial end surfaces of the pivot pins disposed in the housing, e.g. by means of friction produced by the pretension.

This can be achieved advantageously and also in a simple manner in such a way that the pretensioning means comprise an expanding spring arranged on the bushing, which spring sits in an annular groove on the outside circumference of the bushing and rests as a result of its expanding effect with a respective pretension against the axial end surfaces of the two swivel pins which face the same. The shape of the spring can be arranged in such a way that in this case there is no point-like but planar contact on the swivel pins (under the produced pretension).

A large variety of possibilities are known to the person skilled in the art as a means for building up such a pretension, with preferably the pretensioning means comprising an annular spring sitting in an annular groove on the outside circumference of the bushing, which annular spring comprises a bulging portion facing outwardly relative to the bushing, by means of which pressing under pretension can occur against the end surfaces of the swivel pins.

In the case of a sufficiently strongly applied spring action, the supporting flange can be held in any possible swiveling position in relation to the housing and the holder can be held in any possible rotational position in relation to the bushing. This also offers the advantage that the individual parts will not fall apart on their own after assembly.

If such a pretensioning spring concerns an expanding spring for example which is arranged annularly and sits in an annular groove on the outside circumference of the bushing, it can preferably be arranged in such a way that it protrudes substantially from the annular groove only in the region which is opposite to the end surface of the associated swivel pin and presses against said end surface. When viewed from above, such a spring is similar to a lemon. The spring is entrained during the rotation of the twistable holder.

When the spring concerns for example an annular spring disposed in an annular groove on the outside circumference of the bushing, it is advantageous in this case when the holder also comprises a circumferential groove which is radially opposite to the annular groove of the bushing. The inner diameter of this groove corresponds approximately to the distance of the two swivel pins in relation to one another, but it is especially preferably slightly larger, so that the spring is able to exert the desired pressure on the pins. In this embodiment, the annular spring protrudes from the annular groove of the bushing over the entire circumference and presses both against the facing axial end surfaces of the swivel pins and (with their axial end edges) also against the floor of the annular groove of the bushing. In addition to a substantially circularly curved spring, a spring that is curved in a slightly oval manner can preferably be used in certain cases. In this embodiment, the spring does not necessarily have to co-rotate during the turning of the twistable holder.

The pretensioning means are especially preferably arranged and attached in such a way that they also produce a pretension between bushing and twistable holder, thus ensuring that also the holder is held in a self-arresting manner in any twisting position relative to the bushing.

### DESCRIPTION OF THE DRAWINGS

The invention is now principally explained in closer detail by way of example by reference to the drawings, wherein:

FIG. 1 shows a cross section of a connection apparatus in accordance with the invention along a plane of intersections I-I in FIG. 4;

FIG. 2 shows an enlarged view of the detail A of FIG. 1;

FIG. 3 shows an enlarged view of the detail B of FIG. 1;

FIG. 4 shows a sectional view IV-IV of FIG. 1;

FIG. 5 shows arrangement variants of useful expanding springs in the form of so-called “lemon springs”;

FIG. 6 shows an enlarged view of the detail B of FIG. 1, but with a radially outwardly bulging annular spring;

FIG. 7 shows a sectional view of a second embodiment of a connection apparatus in accordance with the invention in analogy to the sectional view of FIG. 1;

FIG. 8 shows an enlarged view of the detail C of FIG. 7;

FIG. 9 shows a third arrangement variant of a connection apparatus in accordance with the invention according to the plane of intersection IX-IX of FIG. 11;

FIG. 10 shows an enlarged view of the detail D of FIG. 9, and

FIG. 11 shows an (enlarged) sectional view of the section XI-XI of FIG. 9.

### DETAILED DESCRIPTION

FIG. 1 shows a connection apparatus 1 in a sectional view according to the sectional position I-I of FIG. 4, which is in a sectional position parallel to the plane of the drawing.

The connection apparatus 1 comprises a supporting flange 2 which can be connected with a load (not shown in the drawings) which can then be lifted by means of a lifting apparatus (not shown) in a suitable manner, e.g. by means of a load chain, a hook or the like which is guided through an opening 3 which is formed by the supporting flange 2 and can then be moved to another location.

The connection apparatus 1 further comprises a housing 4 which comprises a central bushing 5 which opens at its end which is axially at the bottom in the drawing into a radially outwardly expanding annular flange 6 which rises axially slightly upwardly at its radially outwardly disposed end region and thus forms a circumferential annular surface 7.

The housing 4 further comprises a holder 8 which can be twisted about the bushing 5 and which rests with its upper boundary surface on the bottom side of a head part 9 of a supporting bolt 10 when the supporting flange 2 is lifted upwardly.

The holder 8 extends nearly over the entire axial length between the bottom side of the head part 9 and the circumferential annular surface 7 of the annular flange 6, with one downwardly open recess 14 (FIG. 3) each being provided in the holder 8 at two points which are opposite of one another by 180°, into which recess protrudes a swivel pin 11 a and 11 b. The swivel pins 11 a and 11 b are aligned with their central axes in respect of one another and form a rotational axis with the same.

The swivel pins 11 a and 11 b are attached to the bottom end of the supporting flange 2, so that the supporting flange 2 can be swiveled via the same about the rotational axis 12 relative to the housing 4 in a direction perpendicular to the longitudinal central axis 13 of the supporting bolt 10.

The swivel pins 11 a and 11 b each sit with their bottom side on the annular surface 7 of the annular flange 6 of bushing 5, and otherwise in an interlocking manner in the respectively associated recess 14 of holder 8 (cf. FIG. 3). The recesses 14 in holder 8 are dimensioned in their axial length in such a way that the swivel pins 11 a, 11 b which engage into the same have slight play s in them (as seen in the axial direction of supporting bolt 10) (cf. FIG. 3).

The bushing 5 is centrally penetrated by a through-hole 15 (cf. FIG. 3) in which the shank 16 of supporting bolt 10 is accommodated and the supporting bolt 10 is arranged in the mounted state to be twistable relative to bushing 5. The shank 16 comprises a shank region 17 at a certain axial distance a from the bottom side of head part 9 of the supporting bolt 10 and has a slightly enlarged diameter d2.

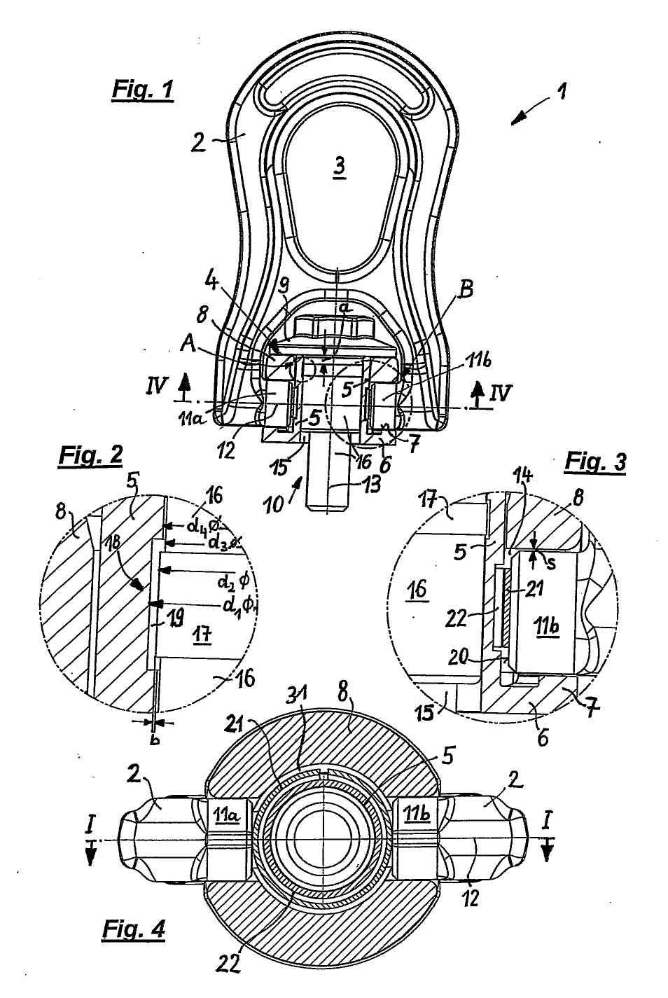

FIG. 2 shows the arrangement of the shank 16 of the supporting bolt 10 within the through-hole 15 of bushing 5 in an enlarged view of detail A of FIG. 1. It shows the shank region 17 with a slightly enlarged diameter d2.

As is also shown in FIG. 2, the bushing 5 comprises a bushing section 18 which is formed by an annular groove 19 and thus forms a bushing region with a similarly enlarged diameter d1, which bushing region is associated with the shank region 17 of enlarged diameter of the supporting bolt 10. The shank section 17 of the supporting bolt 10 protrudes in the mounted state partly into said annular groove 19, as is shown in FIG. 2, which occurs with axial and radial play. The diameter d2 of the shank section 17 is smaller than the associated diameter d1 of the bushing region 18, but larger than the diameter d3 of the remainder of the shank region of the supporting bolt 10 in the through-hole 15 and larger than the diameter d4 of the remaining region of the throughhole 15.

In the embodiment of shank 16 of the supporting bolt 10 as shown in FIGS. 1 to 4, the shank region 17 with an enlarged diameter is arranged to be cylindrical. It can also be arranged in any other form, as will be explained further below in conjunction with the other two embodiments to be described below (FIGS. 7 and 9).

In the cylindrical arrangement, which protrudes into the respective annular groove 19 arranged cylindrically in its cross section, it has proven to be especially advantageous when the radial penetration depth b of the shank region 17 with an enlarged diameter into the annular groove 19 lies in the range of 0.075 mm to 0.1 mm.

The shank 16 of the supporting bolt 10 or supporting bolts 10 on its part is usually made of a material which has a considerably higher strength than the material of the bushing 5 enclosing the same.

FIG. 3 shows the detail B of FIG. 1 also on an enlarged scale.

It shows the conditions in the region of the engagement of the swivel pin 11 b in the holder 8 up to bushing 5.

The illustration shown in FIG. 3 for the swivel pin 11 b applies in an analogous fashion also to the arrangement of the opposite other swivel pin 11 a and its engagement in housing 4.

As is shown in FIG. 3, an expanding spring 21 is provided between the axial end surface 20 of the swivel pin 11 b and the bushing 5, which spring, as is shown in the sectional view according to FIG. 4 (along the line of intersection IV-IV of FIG. 1), encloses the sleeve 5. A circumferential groove 22 (FIG. 3) is attached to the outside wall of the sleeve 5 according to the position of the expanding spring 21, in which the expanding spring 21 partly protrudes in its circumference about the bushing 5. In a respectively associated manner, a circumferential groove 31 is also associated with the same on the inside surface of holder 8 in which the expanding spring 21 also protrudes. When the expanding spring 21 also rests on the groove base of the circumferential groove 22, there is also a self-arresting effect when assuming a relative twisting position between holder 8 and bushing 5 (also see FIG. 11). It can further be amplified in such a way that the expanding spring 21 is arranged in such a way that in its circumference it presses both against the base of the groove 22 and additionally also against the base of groove 31.

The expanding spring 21 transfers a pretension onto the axial end surfaces 20 of the two pins 11 a and 11 b, with said pretension being provided in such a way that the supporting flange 2 is location-positioned in a self-arresting manner in each swiveling position about the rotational axis 12 as a result of the frictional forces produced between the expanding spring 21 and the two end surfaces 20 of the swivel pins 11 a and 11 b. When the expanding spring 212 also rests on the holder 8 in its groove, the pretension also acts upon the holder 8 and the bushing 5, through which the holder 8 is also location-positioned in a self-arresting manner in relation to the bushing 5 about the rotational axis 13.

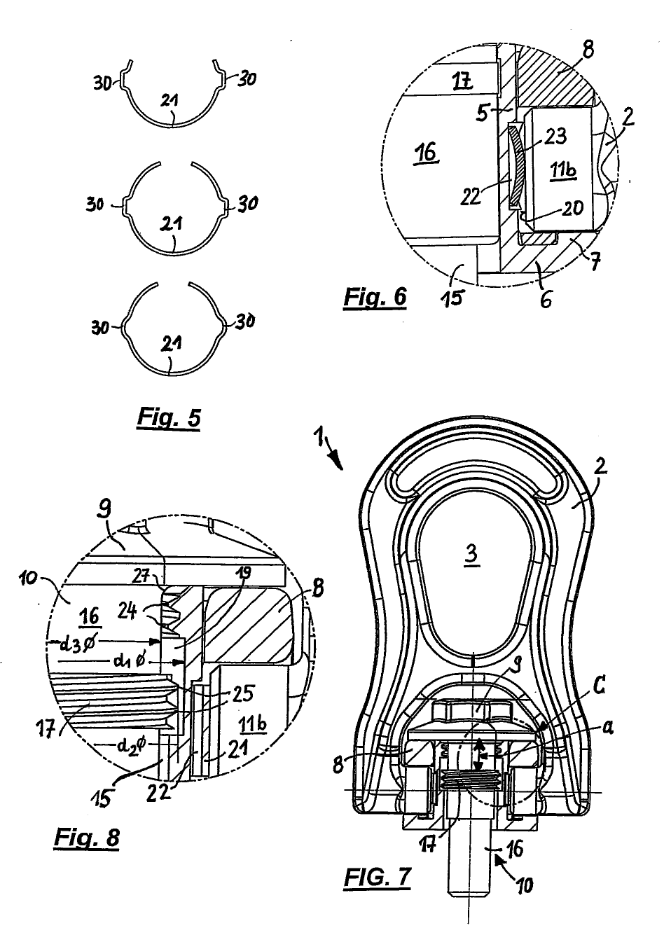

Instead of an expanding spring 21 as shown in FIGS. 1,3 and 4, it would also be possible to use another form of expanding spring, for which purpose three different variants are shown in FIG. 5.

They concern so-called “lemon springs”, which are elastic springs which in the mounted effective state have radial bulges 30 facing outwardly at their two sides facing the two swivel pins 11 a, 11 b, with which a no longer substantially point-shaped or line-shaped but a planar contact can be achieved on the respective end surface 20 of the swivel pins 11 a, 11 b, which contact ensures an especially good transfer of sufficient pretensioning forces onto the facing end surface 20 of the respective swivel pin 11 a or 11 b.

FIG. 6 shows a further embodiment for the useful pretensioning spring in an illustration corresponding to FIG. 3.

In the embodiment according to FIG. 6, the pretensioning spring consists of an annular spring 23 which sits in the groove 22 on the outside of bushing 5, is provided with a bulging portion radially to the outside in an axial sectional view and rests on its bulging outside on the associated end wall 20 of the respective swivel pin 11 a and 11 b and on the floor of groove 22 in bushing 5 with its two axial ends and builds up the respectively desired elastic pressing force against the end surface 20 of the associated swivel pin

11 a and 11 b by the bulging portion. The annular spring 23 can also be arranged in such a way that it additionally builds up a pretension between bushing 5 and the holder 8 and thus also allows a self-arresting location positioning of the latter relative to the bushing 5 in each relative rotational position between the two.

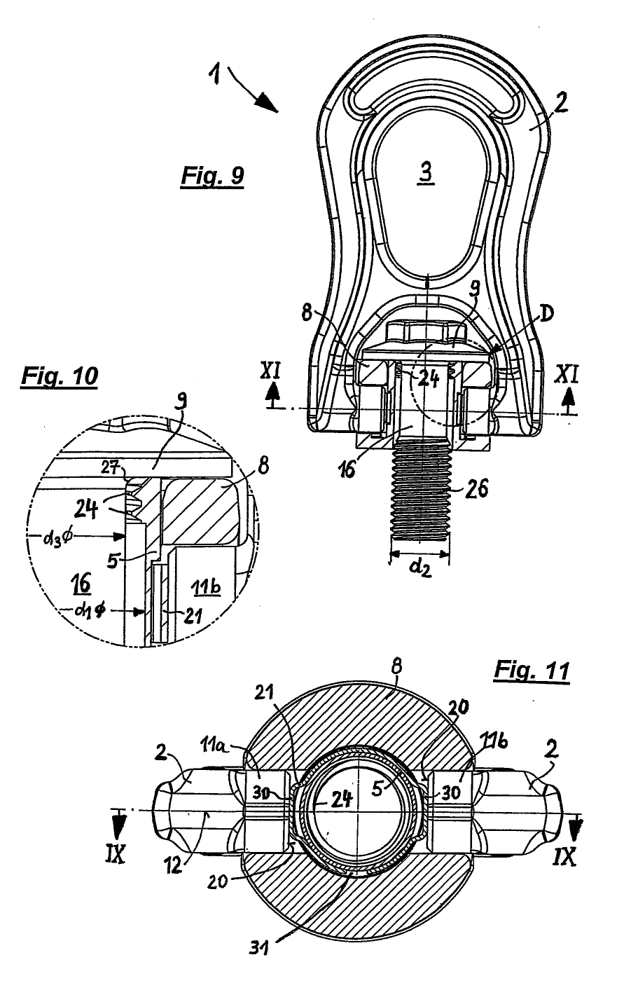

FIGS. 7 and 8 show a further embodiment of a connecting apparatus 1 which differs from the arrangement according to FIG. 1 only by the arrangement of the through-hole 15 and the arrangement of the shank of supporting bolt 10, with FIG. 8 showing an enlarged representation of the detail C of FIG. 7.

In this arrangement, the shank region 17 of enlarged diameter of the supporting bolt 10 consists of an external thread 25 whose flights protrude radially beyond the other shank diameter d3 of the supporting bolt 10 (cf. FIG. 8), with the latter being smaller than the core diameter of the external thread 25 in the shank region 17.

The shank region 17 of enlarged diameter is again remote from the head part 9 at an axial distance a.

The upper entrance region of the lead-through hole 15 also consists of an inside thread section 24, as is shown well in FIG. 8, which section comprises two fully circumferential flights. A circumferential rounded portion 27 is disposed at the upper end of the throughhole 15 which can also be arranged as a chamfered portion for the purpose of easier insertion of the shank 16 of supporting bolt 10 into the through-hole 15.

This section of an inside thread 24 in the upper entrance region of the through-hole 15 reduces the free radial lead-through area of the through-hole 15 there, so that this section of the bushing 5, in the mounted state of the supporting bolt 10, radially partly covers its region 17 of enlarged diameter from the outside and under axial play (in the mounted state), as is shown clearly in FIG. 8.

The inside thread 24 in the upper entrance region of the through-hole 15 is arranged in such a way that the external thread 25 of the shank region 17 of enlarged outside diameter can be screwed through the inside thread 24 during the insertion of the supporting bolt 10 into the through-hole 15, so that the arrangement shown in FIGS. 7 and 8 is obtained in the mounted state of the supporting bolt 10.

As is clearly shown in FIG. 8, the supporting bolt 10 cannot be simply pulled out axially upwardly from the through-hole 15 in the axial mounting end position as shown in FIG. 8, because its shank section 17 is obstructed there from being pulled out by the inside thread 24 which protrudes radially to the inside and partly overlaps the same. The external thread 25 could be guided again through the inside thread 24 only by intentional screwing out and the shank 16 could only then be pulled out.

As is shown further in FIG. 8, in this arrangement too the shank section 17 of enlarged diameter also engages in a bushing section of enlarged inside diameter, which is in the form of an annular groove 19 in the inside wall of bushing 5, with the same being disposed there again both axially and radially with considerable play.

A further third embodiment of a connection apparatus in accordance with the invention is shown in FIGS. 9 to 11, with FIG. 9, as in FIG. 1, showing a sectional view of the connection apparatus 1 according to the sectional position IX-IX of FIG. 11, FIG. 10 showing an enlarged view of the detail D of FIG. 1 and FIG. 11 showing a sectional view in the sectional position IX-IX of FIG. 9.

This embodiment of a connection apparatus 1 in accordance with the invention differs from that according to FIGS. 7 and 8 only in the respect that in this case the shank

region 17 of the supporting bolt 10 of enlarged diameter is formed by the external thread 26 at the end of the shank of supporting bolt 10, which is also used simultaneously for screwing on the load (not shown). This external thread 26 has a core diameter which is larger than the diameter of the other shank 16.

A screw thread for the load to be fastened is also provided in the embodiments of the connection apparatus 1 according to FIG. 1 and FIG. 7, but is not shown in the drawings there.

In FIG. 9 too, the upper entrance region of the through-hole 15 is provided with an inside thread 24 (as in the embodiment according to FIGS. 7 and 8) which protrudes radially to the inside in the through-hole 15 and partly covers radially to the inside the shank region of the end thread 26 protruding radially to the outside (according to the shank region 17 of the supporting bolt 10).

In this embodiment, the shank 16 can be pulled upwardly out of the through-hole 15 over a relatively large axial distance, but a complete withdrawal is not possible because this is again prevented by the inwardly protruding inside thread 24.

The sectional view according to FIG. 10 shows, among other things, the use of a lemon spring 21 according to the embodiment shown in FIG. 5 in the middle as a pretensioning means for pressing against the end surfaces 20 of the swivel pins 11a and 11b for selfarresting fixing of the support flange 2 in a rotary position assumed at random by the same.

1. A connection apparatus for coupling a support flange to a load, comprising a housing having a bushing and a holder for the support flange which is twistable about the bushing, with the support flange being swivelable in the housing about a rotation axis which is disposed perpendicularly in relation to the rotation axis of the holder and a through-hole extends axially through the bushing in which a supporting bolt is rotatably attached with an upper head part, and protrudes axially with its axial end averted from the head part beyond the housing for fixing a load, and is held in the mounted state in an interlocking manner against axial withdrawal from the through-hole, wherein the supporting bolt comprises a shank with a shank region provided at an axial distance (a) from the upper end of the bushing and having a radially enlarged shank diameter (d₂) whose radial excess portion is partly covered radially from the outside in the mounted state under axial play within said axial distance (a) by a bushing section with a reduced inside diameter.

2. A connection apparatus according to claim 1, wherein the shank region with enlarged shank diameter consists of an external thread whose flights form the radial enlargement, and the bushing section with reduced inside diameter consists of an inside thread which corresponds to the thread on the shank region with enlarged shank diameter.

3. A connection apparatus according to claim 1, wherein the inside diameter (d-) of the bushing is arranged to be larger in the region outside of the bushing section with reduced inside diameter than the outside diameter (d₂) of the flights on the shank region with enlarged shank diameter.

4. A connection apparatus according to claim 2, wherein the external thread is formed by an external thread which is provided in the end region of the supporting bolt for screwing on the load, which end region faces the load, with the diameter (d3) of the remaining shank of the supporting bolt being smaller than the core diameter of said external thread.

5. A connection apparatus according to claim 2, wherein the inside thread in the bushing section with reduced inside diameter comprises at least one complete flight.

6. A connection apparatus according to claim 1, wherein the shank region with radially enlarged shank diameter is arranged cylindrically and protrudes into an annular groove provided in a respective manner on the inside surface of the bushing, with the radially enlarged shank region sitting in the annular groove radially and axially with play.

7. A connection apparatus according to claim 1, wherein the supporting bolt with its shaft is made of a material with a higher strength than that of the bushing.

8. A connection apparatus according to one of the claim 1, wherein the bushing is provided at its upper end of its through-hole with a rounded portion or a chamfered portion.

9. A connection apparatus according to one of the claim 1, wherein the supporting flange is held in the housing in such a way that it is fixed in any of its possible swiveling position in a self-arresting way.

10. A connection apparatus according to claim 9, wherein the supporting flange is placed under pretension by means of pretensioning means which act in the direction of its rotational axis and rest on the supporting flange, which pretension holds it in a self-arresting manner in the swiveling direction in any swiveling position of the supporting flange.

11. A connection apparatus according to claim 10, wherein the supporting flange is provided at its bottom end with two mutually facing pivot pins which each engage from the outside into the housing, with the pretensioning means acting upon the axial end surfaces of the pivot pins disposed in the housing.

12. A connection apparatus according to claim 10, wherein the pretensioning means comprise an expanding spring arranged on the bushing, which spring sits in an annular groove on the outside circumference of the bushing.

13. A connection apparatus according to claim 10, wherein the pretensioning means comprise an annular spring sitting in an annular groove on the outside circumference of the bushing.

14. A connection apparatus according to claim 10, wherein the pretensioning means also produce a pretension between the bushing and the twistable holder.
